(19) United States
(12) Patent Application Publication
(10) Pub. No.: US 2025/0245668 A1
(43) Pub. Date: Jul. 31, 2025

(54) RULE GENERATION AND MANAGEMENT USING MACHINE LEARNING

(71) Applicant: PAYPAL. INC., San Jose, CA (US)

(72) Inventors: Zeding Li, Shanghai (CN); Chen Dai, Shanghai (CN); Jian Yang, Shanghai (CN); Qianwen Cai, Shanghai (CN); Xiaomin Lu, Shanghai (CN); Xuan Li, Shanghai (CN)

(21) Appl. No.: 18/704,791

(22) PCT Filed: Jul. 11, 2023
(86) PCT No.: PCT/CN2023/106735

§ 371 Date: Apr. 25, 2024

(51) Int. Cl. G06Q 20/40

(52) U.S. Cl. CPC G06Q 20/405; G06Q 20/4016

(57) ABSTRACT

The disclosed computer-implemented method includes calculating, from transaction data, a statistical change in data entries corresponding to a type of transaction and modeling a transaction rule for normalizing the statistical change by changing an acceptance standard of the type of transaction. The method further includes activating the transaction rule to update a live database system for entering real-time data entries. Various other methods, systems, and computer-readable media are also disclosed.

### CROSS REFERENCE TO RELATED APPLICATION

This application claims the benefit of PCT Application No. PCT/CN2023/106735, filed 11 Jul. 2023, the disclosure of which is incorporated, in its entirety, by this reference.

### BACKGROUND

A transaction system often requires real-time assessment of numerous potential transactions to accept or decline the transactions. The transaction system may utilize transaction rules that for example define certain actions for certain transactions. By assessing various transaction attributes and applying the transaction rules, the transaction system may identify and decline a potentially risky transaction that may be detrimental to the transaction system. For example, declining a fraudulent transaction may prevent incurring a loss. However, overly restrictive rules may result in declining legitimate transactions, which may also result in loss. Over time and numerous transactions, poorly performing transaction rules may, in the aggregate, reduce an effectiveness of the transaction system. Thus, the transaction rules may affect the transaction system's performance with respect to real-time transaction assessment as well as mitigating loss transactions.

The transaction rules are often defined based on analyzing transaction data. Historical transaction data may be analyzed on an offline platform to generate transaction rules that improve the transaction system's performance (for example, loss prevention performance) and which may then be further tested on the offline platform. The rules may be deployed a live platform, which often requires converting a format of the rules from the offline platform to the online platform. However, each milestone in this process may present bottlenecks, which may negatively affect the performance and efficiency of the transaction system.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is a block diagram of an exemplary system for rule generation and management using machine learning.

FIG. 2 is a block diagram of an exemplary network for rule generation and management using machine learning.

FIGS. 3A-3B are flow diagrams of rule generation and management using machine learning.

FIG. 4 is a diagram of an exemplary machine learning scheme.

FIG. 5 is a flow diagram of an exemplary method for rule generation and management using machine learning.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to rule generation and management using machine learning. As will be explained in greater detail below, implementations of the present disclosure detect a statistical change in data entries corresponding to a type of transaction and in response, model a transaction rule to normalize the statistical change. By enabling this transaction rule, the systems and methods herein may improve a real-time performance and efficiency of a computing system for assessing and processing transactions and reduce overhead and computing resources required for post-transaction assessment and management. The systems and methods provided herein may further improve the field of real-time database management by improving rules and/or conditions for generating or entering real-time data in a database, and further improving and allowing more efficient analysis of entered data.

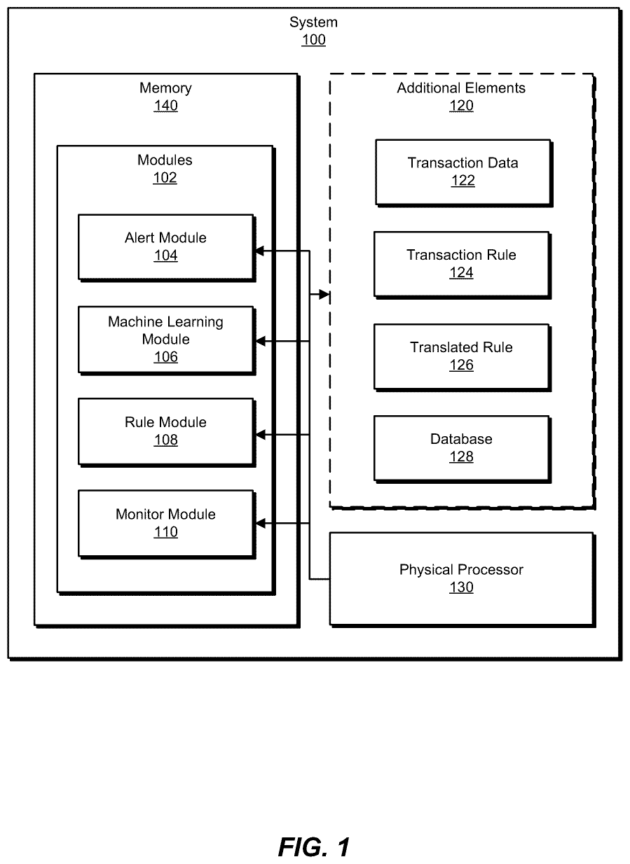

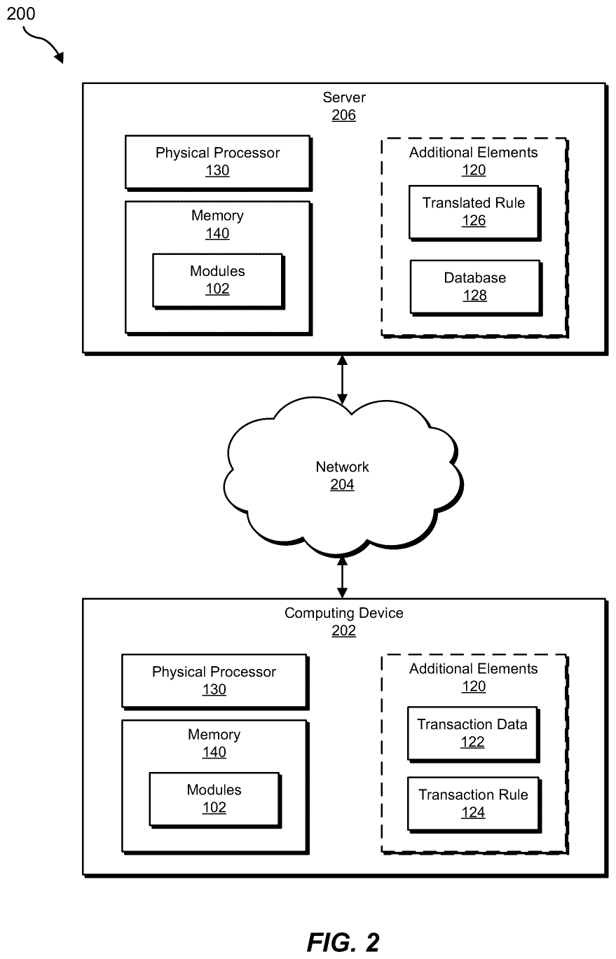

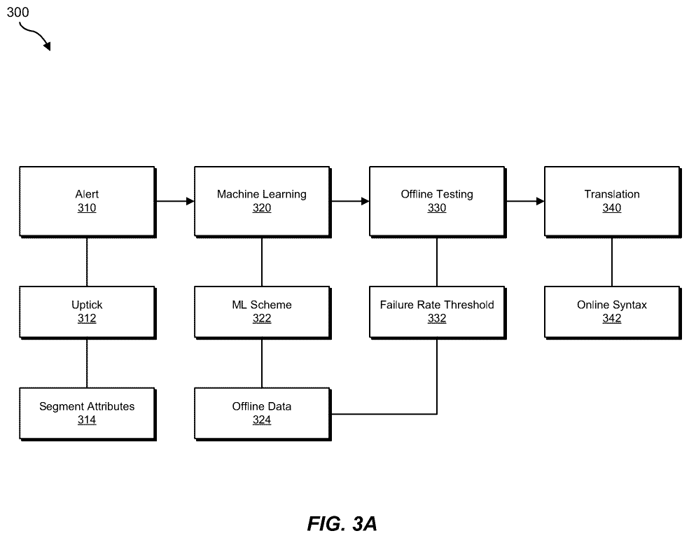

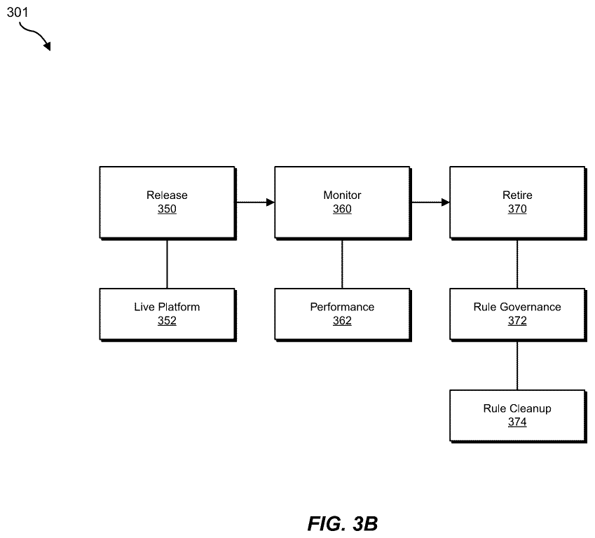

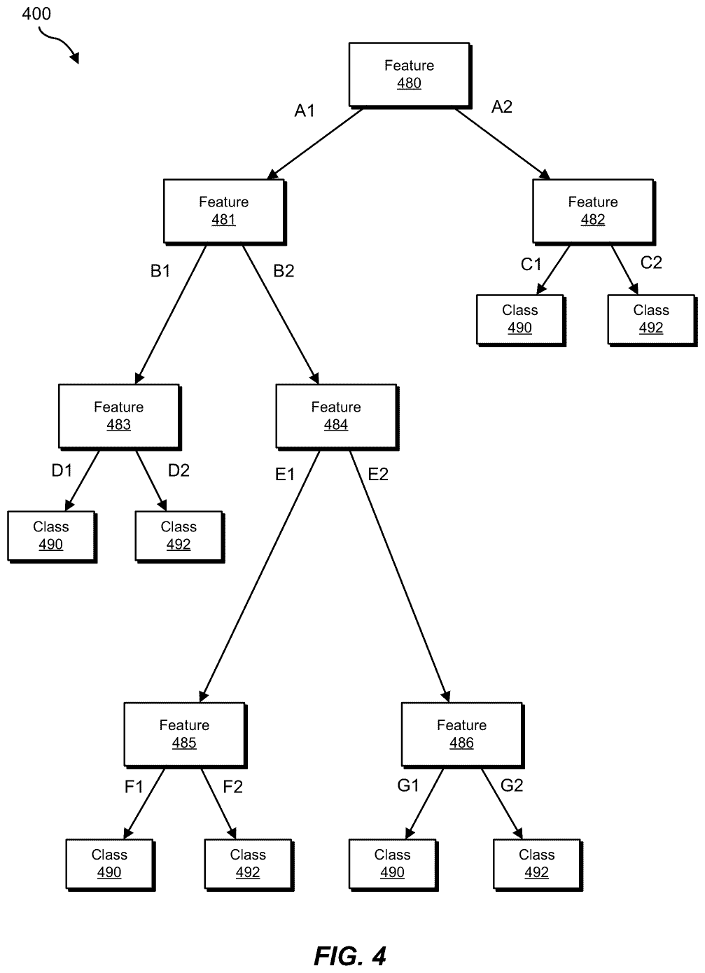

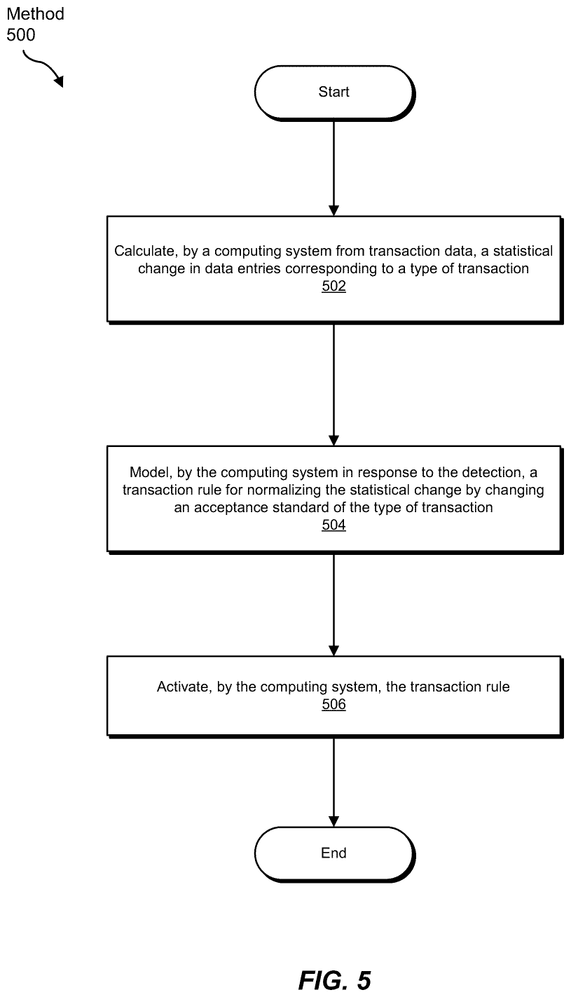

The following will provide, with reference to FIGS. 1-5, detailed descriptions of rule generation and management using machine learning. Detailed descriptions of example computing systems, network architecture, and data capable of implementing one or more of the examples described herein will be provided in connection to FIGS. 1 and 2. Detailed descriptions of example workflows of an off-line platform and a live platform will be provided in connection to FIGS. 3A-3B, respectively. Detailed descriptions of an example machine learning scheme will be provided in connection to FIG. 4. Detailed descriptions of corresponding computer-implemented methods will also be provided in connection with FIG. 5.

FIG. 1 is a block diagram of an example system 100 for rule generation and management using machine learning. As illustrated in this figure, example system 100 includes one or more modules 102 for performing one or more tasks. As will be explained in greater detail herein, modules 102 include an alert module 104, a machine learning module 106, a rule module 108, and a monitor module 110. Although illustrated as separate elements, one or more of modules 102 in FIG. 1 may represent portions of a single module or application.

In certain implementations, one or more of modules 102 in FIG. 1 may represent one or more software applications or programs that, when executed by a computing device, causes the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). In some implementations, a module may be implemented as a circuit. One or more of modules 102 in FIG. 1 may also represent all or portions of one or more special-purpose computers configured to perform one or more tasks.

As illustrated in FIG. 1, example system 100 also includes one or more memory devices, such as memory 140. Memory 140 generally represents any type or form of volatile or non-volatile storage device or medium capable of storing data and/or computer-readable instructions. In one example, memory 140 stores, loads, and/or maintains one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 also includes one or more physical processors, such as physical processor 130. Physical processor 130 generally represents any type or form of hardware-implemented processing unit capable of interpreting and/or executing computer-readable instructions. In one example, physical processor 130 accesses and/or modifies one or more of modules 102 stored in memory 140. Additionally, or alternatively, physical processor 130 executes one or more of modules 102 to generate and maintain transaction rules. Examples of physical processor 130 include, without limitation, microprocessors, microcontrollers, Central Processing Units (CPUs), graphical processing units (GPUs), Field-Programmable Gate Arrays (FPGAs) that implement softcore processors, Application-Specific Integrated Circuits (ASICs), systems on a chip (SoCs), portions of one or more of the same, variations or combinations of one or more of the same, and/or any other suitable physical processor.

As illustrated in FIG. 1, example system 100 also includes one or more additional elements 120, such as transaction data 122, a transaction rule 124, a translated rule 126, and a database 128. Transaction data 122, transaction rule 124, translated rule 126, and/or database 128 may be stored on a local storage device, such as memory 140, or may be accessed remotely. Transaction data 122 represents transaction records, such as completed transactions, pending transactions, canceled transactions, aborted transactions, partial transactions, and/or corresponding attributes and/or features thereof, as will be explained further below. Transaction rule 124 represents one or more rules, conditions, heuristics, etc. that may be used for deciding whether to accept or decline a transaction. Translated rule 126 represents a transaction rule that has been translated from one syntax to another or otherwise modified to work on a different platform than that of the original transaction rule, and in some examples may correspond to a translated version of transaction rule 124. Database 128 represents a database that may include various types of data that was generated and/or entered in real time, such as transaction data 122 and/or other transaction data. In some examples, transaction data 122 can correspond to an offline copy of at least a portion of the transaction data stored in database 128.

Example system 100 may correspond to a transaction system that may allow computing devices to remotely communicate with each other and reach a point of acknowledgement/confirmation therebetween regarding various conditions, which may include a transfer of data that in some examples represents a transfer of money and/or assets. Example system 100 in FIG. 1 may be implemented in a variety of ways. For example, all or a portion of example system 100 represent portions of example network environment 200 in FIG. 2.

FIG. 2 illustrates an exemplary network environment 200 implementing aspects of the present disclosure. The network environment 200 includes computing device 202, a network 204, and server 206. Computing device 202 may be a client device or user device, such as a desktop computer, laptop computer, tablet device, smartphone, or other computing device, and in some examples may correspond to an offline version of a transaction system that may allow analysis of one or more aspects of the transaction system without potentially affecting the transaction system. Computing device 202 includes a physical processor 130, which may be one or more processors, memory 140, which may store data such as one or more of additional elements 120, including at least transaction data 122 and/or transaction rule 124.

Server 206 represents or include one or more servers capable of hosting a live version of a transaction system. Server 206 includes a physical processor 130, which may include one or more processors, memory 140, which may store modules 102, and one or more of additional elements 120, such as translated rule 126 and/or database 128. In some examples, server 206 may correspond to a real-time database system capable of storing data generated in real time, for future processing and/or analysis.

Computing device 202 is communicatively coupled to server 206 through network 204. Network 204 represents any type or form of communication network, such as the Internet, and may comprise one or more physical connections, such as LAN, and/or wireless connections, such as WAN.

A real-time database system (e.g., server 206 and/or example system 100) as described herein may receive data in real time, to be stored in a database (e.g., database 128) and may further use rules (e.g., translated rule 126) to determine what data and/or how data is stored, which may be further processed. The real-time database system may also allow further analysis of at least a portion of the stored data, for example using an offline system (e.g., computing device 202 and/or example system 100) to mitigate potential detriments to a performance of the live system. In some examples, the real-time database system may correspond to a transaction system. A transaction system as described herein may use rules (e.g., translated rule 126 and/or transaction rule 124) for making real-time decisions to complete (e.g., accept) or cancel (e.g., decline) pending transactions, which may be stored as transaction data in a database (e.g., in database 128). In other example, the real-time database system may correspond to other types of databases that may make real-time assessments of potential entries based on configurable rules.

Referring back to FIG. 1, in one example, alert module 104 may detect, from a segment of transaction data 122, a trend of a type of transaction. The segment may correspond to a set of transaction attributes including but not limited to party attributes (e.g., customer type, vendor/merchant type, locations of parties, third parties involved, previous transaction history, and/or other related characteristics), transaction timestamp, assets involved (e.g., amounts of money to be transferred, description and/or types of goods or services, etc.), and/or other relevant information. Thus, the segment may define a particular subset of the transactions in transaction data 122. For instance, the subset may include entries sharing particular types/characteristics of users/parties, corresponding relationships therebetween, temporal relationship (e.g., within a specified time range), etc. The type of transaction may correspond to a particular class/category of transaction. In some examples, the type may correspond to loss transactions, such as transactions resulting in a loss of funds (e.g., due to paying funds for a fraudulent party and/or transaction, and/or loss of potential funds due to declining a legitimate transaction). The trend may correspond to a statistically significant event, such as an upward trend (e.g., an increasing number of over time), a downward trend (e.g., a decreasing number of over time), etc.

In response to the detection, machine learning module 106 may determine a transaction rule (e.g., transaction rule 124) for reversing the trend. Transaction rule 124 may incorporate transaction features determined from the set of transaction attributes. In some examples, machine learning module 106 corresponds to a machine learning model trained using historical transaction data (e.g., transaction data 122). For example, machine learning module 106 may be trained with one or more machine learning schemes using transaction data 122 to take transaction attributes as inputs and identify transaction features of the type of transaction corresponding to the trend. Additionally, in some examples, generating transaction rule 124 may further include producing a transaction rule that satisfies a failure rate threshold with respect to transaction data 122. Machine learning module 106 and/or rule module 108 may test transaction rule 124 to ensure that transaction rule 124 would potentially improve performance of database 128. For example, machine learning module 106 and/or rule module 108 may apply transaction rule 124 to historical transaction data (e.g., transaction data 122) and compare performance (e.g., that transaction rule 124 would produce fewer loss transactions than were produced with the pre-existing rule). In some examples, the failure rate may correspond to a previous performance of a previous rule and in some examples the failure rate may correspond to an acceptable range of performance (e.g., a range between an acceptable number of loss transactions accepted and/or an acceptable number of legitimate transactions declined).

Rule module 108 may translate transaction rule 124 for a live transaction platform (e.g., database 128) and provide (e.g., push) the translated transaction rule (e.g., translated rule 126) to the live transaction platform. Monitor module 110 may monitor a performance of translated rule 126 on the live transaction platform and in some examples may retire translated rule 126 based on the performance falling below a performance threshold. In some examples, the performance threshold may correspond to the failure rate described above and/or otherwise correspond to an acceptable range of performance. By monitoring the performance, monitor module 110 may track realized performance gains of database 128 as well as mitigate potential performance degradation over time.

FIGS. 3A-3B illustrate a flow chart 300 and a flow chart 301, respectively, of rule generation and management using machine learning that may improve a performance of a real-time database system, such as the systems illustrated in FIGS. 1 and/or 2. More specifically, in some examples, flow chart 300 may correspond to an offline system of a transaction system and flow chart 301 may correspond to a live transaction platform of the transaction system. However, in other examples, the offline system and the live transaction platform may correspond to the same system and in yet other examples, the live transaction platform may perform as both the live and offline systems described herein.

At an alert stage 310, the offline system (e.g., computing device 202 and/or system 100) and/or in some examples alert module 104 can identify a trend of a type of transaction from a portion of transaction data (e.g., transaction data 122) that in some examples corresponds to an offline copy of transaction data from the live transaction platform. The portion (e.g., segment) may correspond to a set of transaction attributes. More specifically, the offline system may organize the transaction data into segments defined by segment attributes (e.g., particular transaction attributes) for detecting trends. Such segment attributes may include, for example, transactions involving certain locations (e.g., pairs of locations between parties), characteristics of parties, characteristics of transactions, time (e.g., within a time range such as time of day, day of week, month, etc.), and/or other attributes. Thus, the offline system (and in some examples the live transaction platform itself) may establish various segments, which may in some instances overlap with respect to certain entries. In some examples, the offline system may continuously and/or periodically monitor the transaction data, which may be monitored based on segments.

The offline system may detect an uptick 312 for a segment corresponding to segment attributes 314. For example, uptick 312 may correspond to an upward trend (or, in other examples, any other statistical change) of a particular type of transaction (e.g., loss transactions, although in other examples can correspond to any other type of transaction and/or transaction with specific characteristics such as delayed transactions, erroneous transactions, revoked transactions, automatic transactions, etc.) in the segment corresponding to segment attributes 314. In some examples, the offline system may determine uptick 312 based on the trend satisfying a trend threshold.

The offline system may, in some examples, provide a notification (e.g., to a user and/or to another system) of the identified trend, which may include uptick 312 and/or segment attributes 314. In some examples, the offline system may provide an interface for the user to review this notification and may further provide tools for taking responsive action and/or approving one or more of the steps described herein. Further, the interface may allow the user to adjust detection and/or notification settings.

At a machine learning stage 320, the offline system (e.g., computing device 202 and/or system 100) and/or in some examples machine learning module 106 may use a trained machine learning model to generate a transaction rule (e.g., transaction rule 124) for changing the trend identified at alert stage 310.

In some examples, the trained machine learning (ML) model may use an ML scheme 322 corresponding to one or more machine learning schemes that, in some instances, may be user configurable. The trained machine learning model may be trained using offline data 324 (e.g., transaction data 122) corresponding to an offline copy of live transaction data from the live transaction platform. ML scheme 322 may correspond to one or more machine learning models and/or techniques, such as gradient boosting (e.g., for gradient-boosted decision trees), linear modeling, regression/classification/clustering techniques, etc.

FIG. 4 illustrates an example tree 400 for a tree-based supervised classification model that in some examples corresponds to ML scheme 322. Tree 400 may be organized into various features (e.g., a feature 480, a feature 481, a feature 482, a feature 483, a feature 484, a feature 485, and a feature 486) leading, based on value inputs (e.g., A1-G2) to classes (e.g., a class 490 and a class 492). More specifically, tree 400 may be built, through training on a dataset (e.g., offline data 324) by recursively splitting the dataset into sub-trees based on features, to predict a class from the features. For instance, for feature 480 having a value A2, a classification process may proceed to feature 482, which having a value C1 would predict class 490. In some examples, tree 400 may further be built using a boosted or gradient boosted tree scheme, which may include an ensemble of weaker prediction models (e.g., one or more decision trees such as tree 400) which may use different optimization functions for different regions of tree 400 during a tree-fitting procedure with respect to the dataset.

Returning to FIG. 3A, ML scheme 322 may utilize a tree-based supervised classification model as described herein. ML scheme 322 may additionally use an auto-tuning technique that may allow autonomous identification of suitable parameter configurations for given input data. Moreover, if using the tree-based model or other default model generates a sub-optimal result that fails to satisfy a failure rate threshold (e.g., a failure rate threshold 332 which will be described further below), ML scheme 322 can incorporate or otherwise transition to one or more different ML models for additional flexibility.

The trained machine learning model may be trained, as described above, to generate the transaction rule that incorporates a set of transaction features identified from the set of transaction attributes. The trained machine learning model may use segment attributes 314 to identify relevant transaction features (e.g., corresponding to features 480-486 in FIG. 4) for the transaction rule. For instance, the transaction features may correspond to various thresholds, ranges, and/or other limitations for specific transaction attributes (e.g., pairs of locations between the two parties such as customer location and vendor location that may be in different countries, time of transaction with respect to one or more parties, frequency of transaction of one or more parties, etc.) such that the transaction rule may determine whether to accept or decline a new transaction based on the set of transaction features.

At an offline testing stage 330, the offline system (e.g., computing device 202 and/or system 100) and/or in some examples machine learning module 106 and/or rule module 108 may test the generated transaction rule. The offline system may test the transaction rule using offline data 324 to simulate potential performance on the live transaction platform and determine if the transaction rule provides acceptable performance. For instance, the offline system may use a performance threshold such as a failure rate threshold 332, based on offline data 324, which may correspond to an acceptable failure rate. The testing may include tuning the transaction rule until the transaction rule satisfies failure rate threshold 332.

In determining failure rate threshold 332, offline data 324 may include transaction data describing whether each transaction (e.g., completed or canceled) resulted in success (e.g., an overall positive outcome such as accepting a legitimate transaction and/or declining a loss transaction) or failure (e.g., an overall negative outcome such as accepting a loss transaction and/or declining a legitimate transaction). Failure rate threshold 332 may correspond to an acceptable performance as measured by a failure rate (e.g., a rate of failures when applying a transaction rule to transactions, which in some examples may correspond to a percentage). The offline system may apply the transaction rule to offline data 324 to determine the failure rate. Failure rate threshold 332 may correspond to an improved failure rate compared to a previous failure rate (e.g., being a desired percentage of the previous failure rate, etc.) or other metric.

In some examples, the offline system may tune the set of transaction features of the transaction rule, or otherwise modify and/or regenerate the transaction rule until the transaction rule satisfies failure rate threshold 332. For instance, the offline system may modify parameters of the transaction rule (e.g., the set of transaction features) independently from ML scheme 322. In some examples, the offline system may modify ML scheme 322, such as by updating input parameters to tune the ML model and/or updating offline data 324, and regenerate the transaction rule. Additionally, in some examples the offline system may tune one or both of the transaction rule itself and ML scheme 322 as needed, for instance via multiple iterations of tuning. The offline system may retest the tuned transaction rule (e.g., using the same failure rate threshold 332, although in some instances further using a modified failure rate threshold 332 for instance based on user input, changes to offline data 324 and/or ML scheme 322, etc.) and retune the transaction rule until the transaction rule satisfies failure rate threshold 332.

Further, in some examples the performance threshold may correspond to a real-time performance, such as based on measuring a latency or other delay of the transaction rule and/or a performance effect on other transaction rules and/or functions. Moreover, in some examples, the offline system may provide an interface and/or tools for the user to provide input for adjusting the tuning of the transaction rule (e.g., modifying the transaction features) and/or failure rate threshold 332.

Once the transaction rule satisfies failure rate threshold 332, at a translation stage 340, the offline system (e.g., computing device 202 and/or system 100) and/or in some examples rule module 108 may translate the transaction rule to a translated rule (e.g., translated rule 126) that may be used on the live transaction platform, in some examples by mapping a set of transaction features of the transaction rule to corresponding features on the live transaction platform.

For instance, the offline system may convert the transaction rule to conform with an online syntax 342 of the live transaction platform. In some examples, online syntax 342 may use different variable names for transaction features and/or attributes, and/or may otherwise use different syntax for describing decision-making aspects of the rule. In other words, the offline system may use an offline syntax and vocabulary (e.g., variable names) that were used for analyzing offline data 324 and generating the transaction rule that is different from online syntax 342. The offline system may apply a syntax map for redefining the transaction rule in accordance with online syntax 342, including updating vocabulary (e.g., variable names) as needed.

In some examples, the offline system may automatically perform translation stage 340 in response to the transaction rule satisfying failure rate threshold 332. In some examples, the offline system may provide an interface for the user to approve translation stage 340, which may include specifying online syntax 342 (e.g., specifying between variations, selecting an appropriate syntax for a particular live transaction platform, etc.). Moreover, in some examples, the offline system may skip translation stage 340, for instance if the offline syntax matches online syntax 342.

Turning to FIG. 3B, at a release state 350, the offline system may enable application of the translated rule on the live transaction platform, such as live platform 352 (e.g., server 206, system 100, and/or database 128). In some examples, live platform 352 may be communicatively coupled to the offline system and further in some instances may be a separate portion of the offline system. The offline system may provide the translated rule for automatic enabling on live platform 352. In some examples, the offline system and/or the live transaction platform may provide an interface and/or tools allowing the user to enable the translated rule on the live transaction platform, including, for instance, tools for designating a time of enablement, and/or other restrictions for deploying the translated rule. Accordingly, the offline system may receive, from a user, an instruction to deploy a rule and, in response, may enable application of the instructed rule on the live transaction platform.

At a monitor stage 360, the live transaction platform (e.g., server 206, system 100, and/or database 128) may monitor a performance 362 of the translated rule. Performance 362 may correspond to a success or failure rate of the translated rule with respect to real-time data of the live transaction platform. In some examples, performance 362 may further correspond to a measurement of how the translated rule affects a performance of database 128. In some examples, the live transaction platform may include an interface through which the live transaction platform outputs performance of the translated rule, thereby enabling the user to monitor the real-time performance of the translated rule. The interface may further allow the user to perform actions as needed.

At a retire stage 370, the live transaction platform (e.g., server 206, system 100, and/or database 128) may retire or otherwise disable the translated rule based on a rule governance 372. For example, rule governance 372 may include various metrics and/or heuristics for evaluating the translated rule, such as comparing performance 362 to a performance threshold based on the live transaction platform, including for instance, an acceptable failure rate for the live transaction platform as well as an acceptable real-time performance level of database 128. Rule governance 372 may include disabling the transaction rule based on failing a second performance threshold.

Although the offline system may have previously tested the transaction rule, performance 362 may fail to meet the second performance threshold, which may represent a different acceptable performance than represented by failure rate threshold 332. For example, the second performance threshold may correspond to a change in the acceptable performance level, such as due to a user input or other response to analysis of transactions and/or the live transaction platform itself. In other examples, the second performance threshold may correspond to the same acceptable performance level as failure rate threshold 332 such that failing the second performance threshold corresponds to the transaction rule requiring further modification (which in some instances may require changes to ML scheme 322, offline testing stage 330, and/or failure rate threshold 332). In some examples, the transaction rule may be retired due to changes to the live transaction platform, such as changes to how segments are defined (such that the transaction rule is not needed or is outdated), the availability of a new transaction rule to replace the transaction rule, changes to online syntax 342, etc.

Based on rule governance 372, the live transaction platform may retire the translated rule in accordance with rule cleanup 374. Rule cleanup 374 may include various protocols and/or actions for disabling the translated rule, including using a different transaction rule to replace the retiring rule (e.g., with an updated transaction rule for a similar segment or reverting to a previous and/or default transaction rule), pausing transactions as needed, reporting rule retirement, etc. In some examples, the live transaction platform may include an interface allowing the user to adjust or otherwise modify aspects of rule governance 372 and/or rule cleanup 374. For example, the user may be notified that the transaction rule should be retired based on rule governance 372. In some examples, the user may approve the retiring, or may update rule governance 372 (e.g., by modifying the second performance threshold and/or other parameters), update rule cleanup 374 (e.g., by modifying procedures for rule cleanup 374, selecting a replacement rule, etc.), cancel the retiring, or delay the retiring (e.g., until a planned service interruption, etc.). In some examples, based on updates to rule governance 372 and/or rule cleanup 374, the live transaction platform may resume monitor stage 360.

FIG. 5 is a flow diagram of an exemplary computer-implemented method 500 for rule generation and management using machine learning. The operations shown in FIG. 5 may be performed by any suitable computer-executable code and/or computing system, including the system(s) illustrated in FIGS. 1 and/or 2. In one example, each of the operations shown in FIG. 5 represent an algorithm whose structure includes and/or is represented by multiple sub-operations, examples of which will be provided in greater detail below.

As illustrated in FIG. 5, at step 502 one or more of the systems described herein may calculate, by a computing system from transaction data, a statistical change in data entries corresponding to a type of transaction. For example, computing device 202, system 100, and/or alert module 104 may calculate, from transaction data 122, a statistical change in data entries corresponding to a type of transaction.

The systems described herein may perform step 502 in a variety of ways. In one example, the transaction data may correspond to historical data from a live environment (e.g., server 206 and/or database 128). In some examples, the statistical change in data entries may correspond to a statistically significant change over time. For example, the statistical change in data entries may correspond to an upward trend of loss transactions. In another example, the statistical change in data entries may correspond to a downward trend of completed transactions. In yet other examples, the statistical change may correspond to an undesirable change (e.g., a plateau in a number of transactions of a particular type such as legitimate transactions).

At step 504 one or more of the systems described herein may model, by the computing system in response to the calculation, a transaction rule for normalizing the statistical change by changing an acceptance standard of the type of transaction. For example, computing device 202, system 100, and/or machine learning module 106 may model, in response to the calculation, transaction rule 124 for normalizing the statistical change by changing an acceptance standard of the type of transaction.

The systems described herein may perform step 504 in a variety of ways. In one example, changing the acceptance standard may include determining transaction features resulting in the changed acceptance standard when applied. In some examples, modeling the transaction rule may further include testing the transaction rule, using the transaction data, for changing the acceptance standard to achieve a desired acceptance rate, which may be an increase or a decrease. In some examples, the transaction rule decreases an acceptance rate of risky transactions. In some examples, the transaction rule increases an acceptance rate of risky transactions.

At step 506 one or more of the systems described herein may activate, by the computing system, the transaction rule. For example, computing device 202, server 206, system 100, and/or rule module 108 may activate transaction rule 124 and/or translated rule 126.

The systems described herein may perform step 506 in a variety of ways. In one example, activating the transaction rule further may include enabling the transaction rule in a live environment by translating the transaction rule for a syntax of the live environment. Translating the transaction rule may, in some examples, include converting the transaction rule into a tree structure (e.g., organizing the conditions and/or features into a hierarchy), and converting the tree structure based on the syntax of the live environment (e.g., by mapping analogous conditions and/or features).

In some examples, method 500 may further include monitoring, by the computing system, a performance of the transaction rule in the live environment and providing a notification regarding the performance of the transaction rule.

As detailed above, the systems and methods provided herein may allow proactive and automatic alert detection with seamless data preparation with frequent refreshes. The systems and methods described herein may provide an intelligent auto-solution generation, including rule auto-translation and auto-release, which may further allow rule auto-retirement for ecosystem/platform optimization.

Moreover, as detailed above, the systems and methods described herein may allow improved performance of a live database system. By allowing efficient updating of rules for entering data into the live database system, the systems and methods provided herein may improve how the live database system categorizes and stores data generated in real time, further mitigating an overhead associated with miscategorization of data.

In one implementation, a system for rule generation and management using machine learning includes a processor, and a non-transitory computer-readable medium having stored thereon instructions that are executable by the processor to cause the system to perform operations including (i) detecting, from a segment of transaction data, a trend of a type of transaction, the segment corresponding to a set of transaction attributes, (ii) determining, using a machine learning model trained with the transaction data, a transaction rule for reversing the trend and that incorporates transaction features determined from the set of transaction attributes, (iii) translating the transaction rule for a live transaction platform, (iv) pushing the translated transaction rule to the live transaction platform, and (v) monitoring a performance of the transaction rule on the live transaction platform.

In some examples, the machine learning model is trained with one or more machine learning schemes using the transaction data to take transaction attributes as inputs and identify transaction features of the type of transaction corresponding to the trend. In some examples, generating the transaction rule further comprises producing the transaction rule that satisfies a failure rate threshold with respect to the transaction data. In some examples, the operations further comprise retiring the transaction rule based on the performance falling below a performance threshold.

In some examples, a method for rule generation and management using machine learning may be encoded as computer-readable instructions on a non-transitory computer-readable medium. For example, a computer-readable medium includes one or more computer-executable instructions that, when executed by at least one processor of a computing device, causes the computing device to perform operations including (i) identifying, from a portion of transaction data, a trend of a type of transaction, the portion corresponding to a set of transaction attributes, (ii) providing a notification of the identified trend, (iii) generating, using a trained machine learning model, a transaction rule for changing the trend, that passes a first performance threshold, (iv) enabling the transaction rule, and (v) disabling the transaction rule based on failing a second performance threshold.

In some examples, the trained machine learning model is trained to generate the transaction rule that incorporates a set of transaction features identified from the set of transaction attributes. In some examples, generating the transaction rule further comprises tuning the set of transaction features. In some examples, the transaction rule determines whether to accept or decline a new transaction based on the set of transaction features. In some examples, enabling the transaction rule further comprises mapping a set of transaction features of the transaction rule to corresponding features on a live transaction platform.

In some examples, the first performance threshold is based on the transaction data. In some examples, the second performance threshold is based on a live transaction platform.

In one implementation, a method for rule generation and management using machine learning includes (i) calculating, by a computing system from transaction data, a statistical change in data entries corresponding to a type of transaction, (ii) modeling, by the computing system in response to the calculation, a transaction rule for normalizing the statistical change by changing an acceptance standard of the type of transaction, and (iii) activating, by the computing system, the transaction rule.

In some examples, the statistical change in data entries corresponds to an upward trend of loss transactions and the transaction rule decreases an acceptance rate of risky transactions. In some examples, the statistical change in data entries corresponds to a downward trend of completed transactions and the transaction rule increases an acceptance rate of risky transactions. In some examples, the transaction data corresponds to historical data from a live environment. In some examples, modeling the transaction rule further comprises testing the transaction rule, using the transaction data, for changing the acceptance standard to achieve a desired acceptance rate.

In some examples, activating the transaction rule further comprises enabling the transaction rule in a live environment by translating the transaction rule for a syntax of the live environment. In some examples, the method includes monitoring, by the computing system, a performance of the transaction rule in the live environment. In some examples, the method includes providing a notification regarding the performance of the transaction rule. In some examples, translating the transaction rule further comprises converting the transaction rule into a tree structure, and converting the tree structure based on the syntax of the live environment.

Features from any of the implementations described herein may be used in combination with one another in accordance with the general principles described herein. These and other implementations, features, and advantages will be more fully understood upon reading the following detailed description in conjunction with the accompanying drawings and claims.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

Although illustrated as separate elements, the modules described and/or illustrated herein may represent portions of a single module or application. In addition, in certain implementations one or more of these modules may represent one or more software applications or programs that, when executed by a computing device, cause the computing device to perform one or more tasks. For example, one or more of the modules described and/or illustrated herein represent modules stored and configured to run on one or more of the computing devices or systems described and/or illustrated herein. In some implementations, a module may be implemented as a circuit or circuitry. One or more of these modules may also represent all or portions of one or more special-purpose computers configured to perform one or more tasks.

In addition, one or more of the modules described herein transforms data, physical devices, and/or representations of physical devices from one form to another. For example, one or more of the modules recited herein receives transaction data to be transformed, transforms the transaction data, outputs a result of the transformation to train a machine learning model, uses the result of the transformation to generate a transaction rule, and stores the result of the transformation to enable the transaction rule. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and may be varied as desired. For example, while the steps illustrated and/or described herein are shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a processor; and
a non-transitory computer-readable medium having stored thereon instructions that are executable by the processor to cause the system to perform operations comprising:
detecting, from a segment of transaction data, a trend of a type of transaction, the segment corresponding to a set of transaction attributes;
determining, using a machine learning model trained with the transaction data, a transaction rule for reversing the trend and that incorporates transaction features determined from the set of transaction attributes;
translating the transaction rule for a live transaction platform;
pushing the translated transaction rule to the live transaction platform; and
monitoring a performance of the transaction rule on the live transaction platform.

2. The system of claim 1, wherein the machine learning model is trained with one or more machine learning schemes using the transaction data to take transaction attributes as inputs and identify transaction features of the type of transaction corresponding to the trend.

3. The system of claim 1, wherein generating the transaction rule further comprises producing the transaction rule that satisfies a failure rate threshold with respect to the transaction data.

4. The system of claim 1, wherein the operations further comprise retiring the transaction rule based on the performance falling below a performance threshold.

5. A non-transitory computer-readable medium having stored thereon instructions that are executable by a processor of a computing system to cause the computing system to perform operations comprising:
identifying, from a portion of transaction data, a trend of a type of transaction, the portion corresponding to a set of transaction attributes;
providing a notification of the identified trend;
generating, using a trained machine learning model, a transaction rule for changing the trend, that passes a first performance threshold;
enabling the transaction rule; and
disabling the transaction rule based on failing a second performance threshold.

6. The non-transitory computer-readable medium of claim 5, wherein the trained machine learning model is trained to generate the transaction rule that incorporates a set of transaction features identified from the set of transaction attributes.

7. The non-transitory computer-readable medium of claim 6, wherein generating the transaction rule further comprises tuning the set of transaction features.

8. The non-transitory computer-readable medium of claim 6, wherein the transaction rule determines whether to accept or decline a new transaction based on the set of transaction features.

9. The non-transitory computer-readable medium of claim 8, wherein enabling the transaction rule further comprises mapping a set of transaction features of the transaction rule to corresponding features on a live transaction platform.

10. The non-transitory computer-readable medium of claim 5, wherein the first performance threshold is based on the transaction data.

11. The non-transitory computer-readable medium of claim 5, wherein the second performance threshold is based on a live transaction platform.

12. A computer-implemented method comprising:
calculating, by a computing system from transaction data, a statistical change in data entries corresponding to a type of transaction;
modeling, by the computing system in response to the calculation, a transaction rule for normalizing the statistical change by changing an acceptance standard of the type of transaction; and
activating, by the computing system, the transaction rule.

13. The method of claim 12, wherein the statistical change in data entries corresponds to an upward trend of loss transactions and the transaction rule decreases an acceptance rate of risky transactions.

14. The method of claim 12, wherein the statistical change in data entries corresponds to a downward trend of completed transactions and the transaction rule increases an acceptance rate of risky transactions.

15. The method of claim 12, wherein the transaction data corresponds to historical data from a live environment.

16. The method of claim 15, wherein modeling the transaction rule further comprises testing the transaction rule, using the transaction data, for changing the acceptance standard to achieve a desired acceptance rate.

17. The method of claim 12, wherein activating the transaction rule further comprises enabling the transaction rule in a live environment by translating the transaction rule for a syntax of the live environment.

18. The method of claim 17, further comprising monitoring, by the computing system, a performance of the transaction rule in the live environment.

19. The method of claim 18, further comprising providing a notification regarding the performance of the transaction rule.

20. The method of claim 17, wherein translating the transaction rule further comprises converting the transaction rule into a tree structure, and converting the tree structure based on the syntax of the live environment.
